(19) United States
(12) Patent Application Publication
(10) Pub. No.: US 2019/0293116 A1
(43) Pub. Date: Sep. 26, 2019

(54) SPHERICAL BEARING SYSTEM

(71) Applicant: GE Aviation Systems, LLC, Grand Rapids, MI (US)

(72) Inventors: Gurudatta Sirigere, Bangalore (IN); Narendra Dev Mahadevaiah, Bangalore (IN)

(73) Assignee: GE Aviation Systems, LLC, Grand Rapids, MI (US)

(21) Appl. No.: 16/466,275

(22) PCT Filed: Nov. 20, 2017
(86) PCT No.: PCT/US2017/062611

§ 371 Date: Jun. 3, 2019

(30) Foreign Application Priority Data
Dec. 3, 2016 (IN) 201611041410

(51) Int. Cl. F16C 23/04

(52) U.S. Cl. CPC F16C 23/045; F16C 2226/60; F16C 2326/43

(57) ABSTRACT

Provided is an annular matching device indulging a spherical bearing including an inner surface, and an exterior surface movably attached to the inner surface, the inner and exterior surfaces including a bore. Also included is a fastener configured to extend through a first workpiece and through the bore. The spherical bearing is configured to be placed in a second workpiece; and the second workpiece is configured to be moved adjacent to the first workpiece via an engager.

### TECHNICAL FIELD

The present innovation relates generally to eliminating angular mismatches between mating surfaces. In particular, the present innovation relates to enhancing structural integrity by eliminating mismatches when mating surfaces, such as hinged ribs, are bolted to a beam during assembly.

### BACKGROUND

Ribs and beams, used interchangeably, are well known generic structural members that are fundamental to aircraft construction and are used throughout the aeronautics industry. Ribs and beams are a piece of stronger or thicker material across a surface or through a structure, and typically serves to support or strengthen the structure. However, accommodating imperfections in the manufacture of these ribs and gear beams (e.g., gear beams) can be costly and time-consuming.

For example, ribs and gear beams used in aircraft structures may easily pass inspection in the initial stage of inspection after manufacture. During assembly, however, mismatches or gaps can occur between ribs and beam posts. These gaps can compromise the structural integrity of the underlying aircraft or avionics system. Although gaps can occur for a variety of reasons, their severity and impact are generally a function of the length of the rib.

Ribs and gear beams may be manufactured to be different lengths. Consequently, when assembling the gear beam and rib into an assembly, these manufacturing disparities can create corresponding disparities in alignment between the rib and gear beam. By way of example, an imperfect alignment can create an angular mismatch, creating the aforementioned gap. Thus, angular mismatches should be avoided for structural integrity purposes.

One conventional approach to eliminating the mismatch, or gaps, includes adding a liquid shim. The approach of adding liquid shim, however, requires an enormous amount of assembly time due to the steps of measuring, shimming, and allowing the liquid shim to cure. For example, the liquid shim typically requires about 4-8 hours to cure.

Other conventional approaches of eliminating angular mismatches include tightening the nut and pulling the rib to match the beam post, providing a tighter tolerance for parts to minimize the mismatch. A disadvantage of tightening the nut and pulling the rib to match the beam post is the risk of stripping the bolt. Fettling, purposely thickening the ribs at the beam post interface, is also used.

Tightening the nut also creates built stress in parts, inducing fatigue. Additionally, having a tighter tolerance for parts to minimize the mismatch can create difficulties in finding ribs and gear beams that perfectly match. Angular mismatch can be eliminated by machining ribs and beams with tighter tolerances, but manufacturing cost will increase. Fettling is also a time consuming process.

### SUMMARY

Various aspects of the present innovation provide cost-effective and efficient techniques that eliminate angular mismatches in loaded planar structures.

More specifically, the aspects described herein provide a technique of using a spherical bearing at locations where ribs and beams interface or interact. During assembly, in accordance with the various aspects, the spherical bearings will self-align to the beam post surface when the nut is tightened. In this manner, mismatches between these two component surfaces will be absorbed by bearing rotation.

The techniques provided by the various aspects are cost effective and decrease assembly time. During the assembly, the spherical bearings begin to self-align to the beam post surface when the fastener is tightened. The bearing rotation is configured to absorb the mismatch between the surfaces and maintain the components positions.

Under certain circumstances, the embodiments provide an annular matching device indulging a spherical bearing including an inner surface, and an exterior surface movably attached to the inner surface, the inner and exterior surfaces including a bore. Also included is a fastener configured to extend through a first workpiece and through the bore. The spherical bearing is configured to be placed in a second workpiece; and the second workpiece is configured to be moved adjacent to the first workpiece via an engager.

Technical advantages of the embodiments include ease of assembly, deterministic load path, simpler analysis, reduced weight, and the like. Commercial advantages of the present innovation include reduced cost and reduced assembly time.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 is an illustration of assembly of typical ribs and gear beams.

FIG. 2 is an example illustration of a spherical bearing used in accordance with various aspects described herein.

FIG. 3 is an example illustration of a panel rib embedded with two spherical bearings in accordance with various aspects described herein.

FIG. 4 is an illustration of the spherical bearing system in accordance with the various described aspects.

FIG. 5 is an illustration of an angular mismatched connection between the panel rib and gear beam, depicted in FIG. 4, in accordance with the various described aspects.

FIG. 6 is an illustration of a self-align connection depicted in FIG. 4, in accordance with the various described aspects.

### DETAILED DESCRIPTION

While the illustrative aspects of the innovations are described herein for particular applications, it should be understood that the present disclosure is not limited thereto. Those skilled in the art and with access to the teachings provided herein will recognize additional applications, modifications, and aspects of the innovations within the scope thereof and additional fields in which the present disclosure would be of significant utility.

Reference will be made below in detail to exemplary aspects of the innovations, examples of which are illustrated in the accompanying drawings. Wherever possible, the same reference numerals used throughout the drawings refer to the same or like parts.

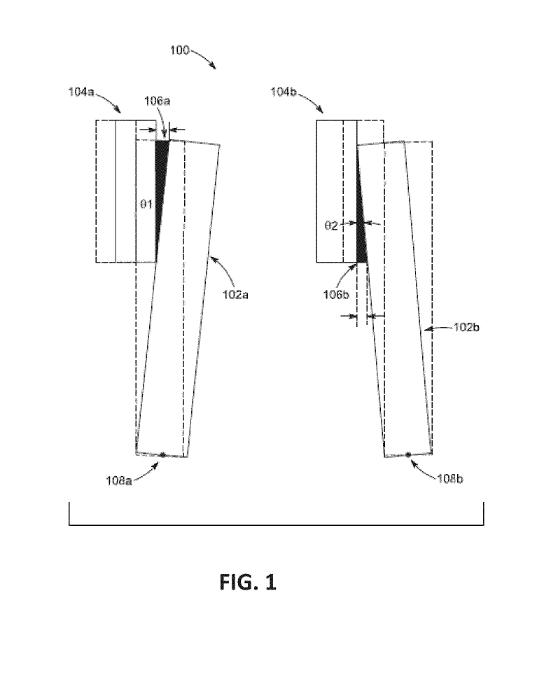

FIG. 1 is an illustration of challenges associated with the assembly of typical ribs and gear beams. The system 100 depicts an attachment of a rib 102 to a gear beam 104. Dotted lines represent nominal positions and solid lines represent worst case positions of the rib 102 and gear beam 104 in the assembly. 102a and 102b are opposing ends of the rib, and 104a and 104b are opposing ends of a gear beam. The rib 102 can be attached to a stationary structure via hinge points 108a and 108b.

As illustrated in FIG. 1, ends of the gear beam 104 and the rib 102 may not align. The mis-alignment leaves possible gap(s) 106a and 106b. These gaps may compromise the structural integrity of the assembly of planar structures. Various aspects of the embodiments are directed toward alleviating the gap(s) 106a and 106b, and properly aligning the gear beam 104 and the rib 102 using spherical bearings.

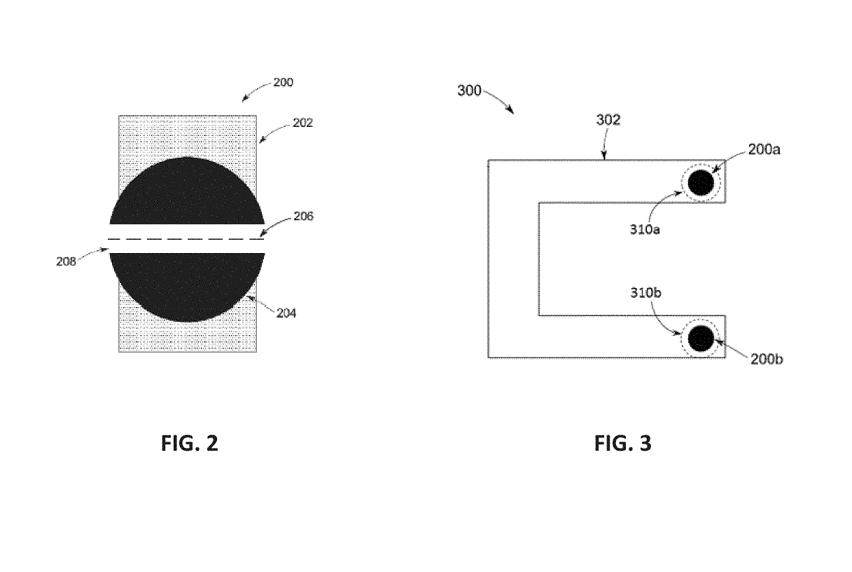

FIG. 2 is an illustration of a sliced side view of a spherical bearing 200 in accordance with various described aspects. The basic structure of the spherical bearing includes an inner race (ball) 204 and an outer race (sleeve) 202 that encases the inner race 204. The inner race 204 and the outer race 202 are essentially inner and outer surfaces of the spherical bearing 200.

Typically, the inner race 204 of the spherical bearing 200 is adapted to receive a fastener (e.g., bolt). The fastener has a diameter that is chosen, selected, or otherwise based on a shear load to be carried by the fastener. For example, the shear load can be the component of stress on the fastener of attaching the rib 102 to the gear beam 104. The inner race 204 is located within the outer race 202. The outer race 202 allows the inner race 204 to rotate and adjust to absorb the angular mismatch between spherical bearings and ribs.

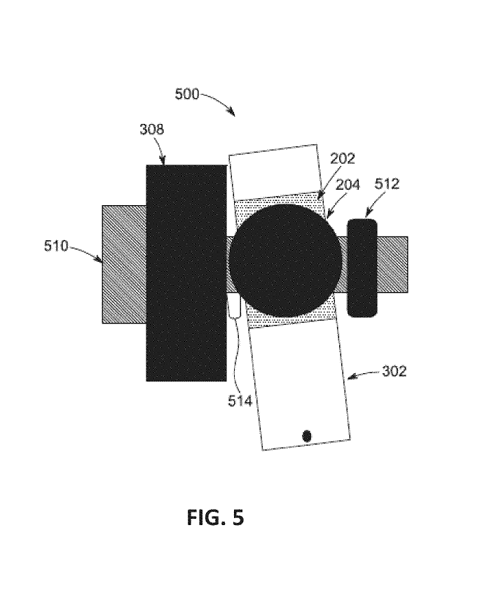

The spherical bearings may also comprise a locking feature that enables the inner race 204 to be captive within the outer race 202 in the axial direction. The inner race 204 is configured to maintain the structural integrity of the rib 102a/102b and the gear beam 104a/104b. The diameter 206 of the spherical bearing 200 can be based on a diameter of the fastener. For example, larger shear loads may require larger bolt diameters and larger spherical bearings. The spherical bearing 200 also includes a channel 208, or bore, through a central section through which a fastener (as shown in FIG. 5), such as a screw, can be inserted.

FIG. 3 illustrates a structure 300 including a rib 302 structured to accommodate at least two spherical bearings 200a and 200b. The spherical bearings 200a and 200b are embedded within the rib (i.e., first workpiece) 302 via openings 310a and 310b within the rib 302. The outer race 202 (as shown in FIG. 2) of the spherical bearings 200a and 200b are affixed to the rib 302 in the openings 310a and 310b.

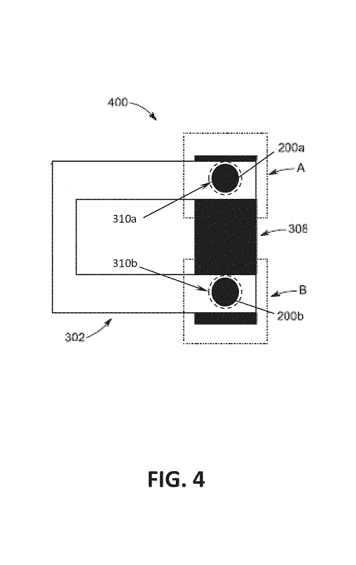

For example, the assembly of the spherical bearings 200a and 200b being affixed to the rib 302 may be achieved by a swaging operation or interference fit. As discussed previously, the inner race 204 is located within the outer race 202. The inner race 204 is configured to rotate about the outer race 202. The inner race 204 possesses angular capability. Additionally or alternatively, the spherical bearings 200a and 200b can be embedded within a gear beam (i.e., second workpiece) 308 (see FIG. 4). For example, openings, similar to the openings 310a and 310b, may be incorporated into the gear beam 308. The outer race 202 can then be affixed to the gear beam 308 via the similar openings.

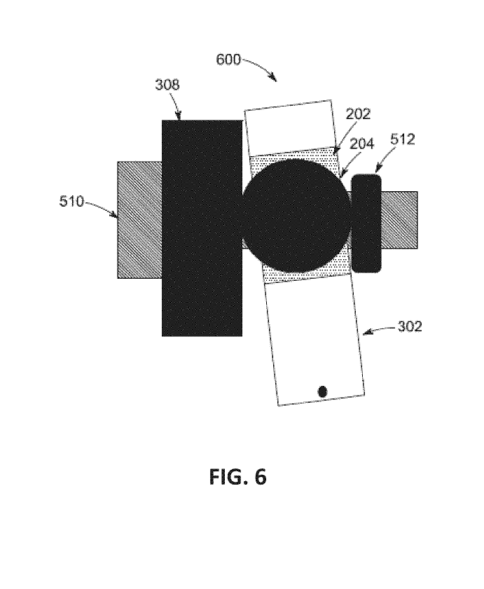

FIG. 4 illustrates an assembled structure 400 depicting the rib 302 affixed to the gear beam 308. In this illustration, and as depicted in FIG. 3, the spherical bearings 200a and 200b are respectively inserted into the openings 310a and 310b. This insertion optimally positions the spherical bearings 200a and 200b for attachment to the gear beam 308 via a fastener and an engager, as discussed below with respect to FIGS. 5 and 6.

Once the rib 302 is attached to the gear beam 308, the potential for angular mismatch occurs at sections A and B between the gear beam 308 and rib 302. However, in the various aspects of the innovation, the spherical bearings 200a and 200b self-align the angular mismatch between the gear beam 308 and the rib 302. The self-aligning can occur when incorporating spherical bearings 200a and 200b at positions depicted in FIG. 4.

FIG. 5 is a side view illustration of an interface 500 between the gear beam 308 and the rib 302 in section A/B of FIG. 4. The outer race 202 is affixed to the rib 302. Fastener 510 attaches gear beam 308 and rib 302, via an engager 512 through the spherical bearing 200a/200b, in section A/B of FIG. 4.

As illustrated in FIG. 5, an angular mismatch 514 exists. However, inner race 204 self-aligns as fastener 510 is being tightened. The self-aligning eliminates the angular mismatch 514. The outer race 202 enables the inner race 204 to rotate and adjust as the fastener 510 is being tightened. The rib 302 will structurally integrate the gear beam 308 retaining the load path connectivity with the gear beam 308, in spite of the angular variation 514 between rib 302 and the gear beam 308.

FIG. 6 is a side view illustration of the interface 600 between the gear beam 308 and rib 302 in Section A/B of FIG. 4 after the angular mismatch has been self-aligned by the spherical bearing 200. The fastener 510 is threaded through the gear beam 308, the inner race 204 of the spherical bearing 200, the rib 302, and an engager 512. As illustrated, the inner race 204 of the spherical bearing 200 has self-aligned as the fastener 510 was tightened into the engager 512. The outer race 202 allowed for the inner race 204 to self-align and absorb the angular mismatch 514. Once, the angular mismatch has been absorbed, the gear beam 308 and rib 302 align themselves together.

The various aspects of the innovation provide numerous ways in which a rib 302 can be connected to a gear beam 308. For example, in some illustrious embodiments, the rib 302 is connected to the gear beam 308 via at least three spherical bearings 200. The ribs 302 and gear beams 308 can vary in size by width, length, and shape. By way of example only, and not limitation, the rib 302 can be a singular U-shaped element. The spherical bearings 200 can be spherical plain bearings, spherical ball bearings, spherical roller bearings, spherical rod end bearings, etc. The spherical bearings 200 can range in diameter depending on the shear load to be carried.

Several types of spherical bearings 200 are possible based on the assembly of inner race 204 and outer race 202 and the method of lubrication between the inner race 204 and outer race 202. The type of bearings is also dependent upon the method of assembling the outer race 202 to the main structural part of rib 302.

In the various embodiments, the spherical bearings 200 are typically located in between the rib 302 and the gear beam 308. The spherical bearing 200 can either be embedded into the gear beam 308, or embedded into the rib 302. Additionally, the assembly of the spherical bearing 200 can be implemented by a swaging operation or via an interface fit.

Alternative aspects of the embodiments, examples, and modifications which would still be encompassed by the disclosure may be made by those skilled in the art, particularly in light of the foregoing teachings. Further, it should be understood that the terminology used to describe the disclosure in intended to be in the nature of words of description rather than of limitation.

Those skilled in the relevant art(s) will appreciate that various adaptations and modifications of the innovation described above can be configured without departing from the scope and spirit of the disclosure. Therefore, it is to be understood that, within the scope of the appended claims, the disclosure may be practiced other than as specifically described herein.

What is claimed is:

1. An annular matching device comprising:
a spherical bearing including an inner surface, and an exterior surface movably attached to the inner surface, the inner and exterior surfaces including a bore; and
a fastener configured to extend through a first workpiece and through the bore;
wherein the spherical bearing is configured to be placed in a second workpiece; and
the second workpiece is configured to be moved adjacent to the first workpiece via an engager.

2. The annular matching device of claim 1, wherein the fastener is further configured to engage the engager.

3. The annular matching device of claim 2, wherein the spherical bearing is configured to absorb an angular mismatch of the first workpiece and the second workpiece while the fastener engages.

4. The annular matching device of claim 1, wherein a diameter of the spherical bearing is based on a diameter of the fastener.

5. The annular matching device of claim 4, wherein the diameter of the fastener is based on a shear load to be carried.

6. The annular matching device of claim 1, wherein the first workpiece comprises at least two spherical bearings.

7. The annular matching device of claim 1, wherein the fastener is a bolt.

8. The annular matching device of claim 1, wherein the engager is a nut.

9. The annular matching device of claim 1, wherein the first workpiece is at least one of u-shaped, or a complete planar structure.

10. The annular matching device of claim 1, wherein the second workpiece is at least one of u-shaped or a complete planar structure.

11. The annular matching device of claim 1, wherein the first workpiece is attached to a fixed structure via a hinge joint.

12. The annular matching device of claim 1, wherein the first workpiece is attached to a fixed structure via a third spherical bearing.

13. The annular matching device of claim 1, wherein an interface between the inner surface and the exterior surface is dry lubrication.

14. The annular matching device of claim 1, wherein the spherical bearing comprises a roller bearing between the inner surface and the exterior surface.

15. The annular matching device of claim 1, wherein the embedding of the spherical bearing into the at least two openings can be by any method such as swaging operation or interference fit.

16. An annular matching device comprising:
a first workpiece comprising an opening;
a spherical bearing affixed to the opening;
a second workpiece; and
a fastener extendable through the spherical bearing and the second workpiece into an engager;
wherein the spherical bearing is configured to absorb angular mismatch between the first workpiece and the second workpiece.

17. The annular matching device of claim 16, wherein the spherical bearing comprises an inner surface, an exterior surface, and a bore through the inner surface.

18. The annular matching device of claim 16, wherein the first workpiece comprises a second spherical bearing.

19. The annular matching device of claim 16, wherein a diameter of the spherical bearing is based on a diameter of the fastener.

20. The annular matching device of claim 17, wherein the diameter of the fastener is based on the shear load to be carried.
